(19) United States
(12) Patent Application Publication
(10) Pub. No.: US 2003/0184041 A1
(43) Pub. Date: Oct. 2, 2003

(54) Devices set for motor-less vehicle for biking upright

(76) Inventor: Pol Raikin, Akko (IL)

Correspondence Address: Pol Raikin, P.O. Box 2680 Hotel Argaman 65, Akko, 24126, IL

(21) Appl. No.: 10/107,187

(22) Filed: Mar. 28, 2002

(51) Int. Cl. B62M 1/00

(52) U.S. Cl. 280/230

(57) ABSTRACT

Devices set for biking upright enables to apply an additional effort cyclist to the operator-powered vehicle. The set contains supports with additional pedal levers and a sprocket embraced by the driving chain of the vehicle. This sprocket is connected to the levers by virtue of free wheeling mechanism. The set may also include supporting poles for the upright cyclist. The set can be mounted virtually on any bicycle, so that to improve its operational parameters. A vehicle with devices set can become a day-to-day transportation means and fitness-improving means, since the partners can exchange places during the journey. Different modification tricycles with the devices set mounted on them can be adopted for two or even three partners in addition to the main cyclist. Including the devices set as mentioned above together with a pedal cartridge containing a free wheeling mechanism creates a new type of a motor-less vehicle for biking upright.

### BACKGROUND OF THE INVENTION

1. Field of the Invention

The present invention relates to individual transport means and more particularly to operator powered vehicle such as a bicycle, tricycle, tandem bicycle, scooter and to accompanying sets and devices as well as to sporting devices and trainer-simulators.

2. Description of the Related Art

In all the variety of available operator powered vehicles special attention should be paid to those enabling activation of the greatest number of strong groups of human muscles (for example bicycle disclosed in Russian Pat. No. 1.698.123, March 1993, Raikin, Int. Cl. B62K March 2000), and also activation of the cyclist weight during riding (refer for example to U.S. Pat. No. 4,349,566, April 1983, Titcomb, U.S. Cl. 280/251 Int. Cl. B62K 21/18 or to the scooter disclosed in U.S. Pat. No. 6,273,439 B1. August 2001 Ray et. al, U.S. Cl. 280/87/041 Int., Cl. B62M January 2000). Attention should be also paid to additional possibilities, which are open when riding with a partner, while combing the efforts of both sitting cyclists, for example as in the sectional tandem bicycle disclosed in U.S. Pat. No. 5,836,600, November 1998, Chiu, U.S. Cl. 280/231 Int., Cl. B62K 27/00. However, the solutions mentioned above did not gain significant prevalence as a day-to-day transport means, first of all because of inadequate level of their operational functionality. The reason was the absent of tandem design or additional sets and devices for the human powered vehicle, which could have allow each cyclist alternate straightening up of his spine during riding upright while using his physical possibilities in the most efficient manner by combing the effort of his numerous strong muscles, his body weight and simultaneously the partner-rider's effort. The lack of mentioned designs or auxiliary devices restrains improvement of operational functionality of the human powered vehicle and to use it as a day-to-day transport means. None of the above inventions and patents, taken either singly or in combination, is seen to describe the instant invention as claimed.

### SUMMARY OF THE INVENTION

The aim of the present invention is to extend the possible use of vehicle as a day-to-day transport means and simultaneously as physical training and fitness tool, significantly improving its functional parameters (power, velocity, distance of riding) without substantial design complications and increase of weight, dimensions and cost. The above aim is attained through more efficient use of the efforts of two or more cyclist-partners, when at least one of them rides upright; Moreover, a possibility is also provided for the riders to exchange seats and poses when stopping in order to change the character of their physical effort and enable the relaxation of certain muscle groups as well as straightening the spine.

Accordingly, it is a principle object of the invention to create a devices set for motor-less vehicle for biking upright, which consists of the following parts:

Supports designed for rigid mounting on the operator-powered vehicle next to its rear wheel;

Semi-axles for pairwise and coaxial mounting, each one on its respective support;

Levers, for example rocker-shaped, with feet pedals for the upright cyclist for hinged mounting on the mentioned semi-axles, which are pairwise rigidly interconnected;

A spring with one end should be connected to the above mentioned pedal lever and the other end should be rigidly mounted relative to the frame of the mentioned vehicle, used for accumulation of tilt energy of pedal levers pushed by the mentioned cyclist;

A sprocket should be mounted on one of the semi-axles embraced by driving chain of the vehicle power transmission connected to pedal lever by using a free wheeling device, for example a ratchet gear, which transmits the effort of the mentioned cyclist to the driving chain to allow its motion in the working direction.

The described set may also contain supporting poles grasped by the upright cyclist and other additional assemblies and details in depend of the consumer needs.

It is another object of the invention to provide a motor-less vehicle, particularly bicycle containing the following parts: a frame, a handle bar, front and rear wheels, a power transmission chain, a handbrake and in addition a pedal cartridge supplemented by a free wheeling mechanism and the devices set, mentioned above.

It is a further object of the invention to provide improved elements and arrangements thereof in a devices set for the purposes described, which is inexpensive, dependable and fully effective in accomplishing its intended purposes.

The estimated pair cycling performance buildup with the set mounted on the bicycle in comparison with a single rider cycling is as follows:

The developed power increase 2.5-times;

The riding velocity increase 1.5-times;

The riding distance increase without physical overload 3-times;

The climbed slopes steepness increase 1.5-times;

The physiological training effect increase 2.5-times;

At the same time the bicycle dimensions remain the same and its weight and cost are increased only by 5-10%.

The power transmission driving chain gets longer.

For heavy riders a more powerful vehicle rear wheel could be needed.

Thus, daily pair cycling for 10-15 km contributes to harmonic body shaping of the cyclists and to their fitness. It also provides an ecological effect. Moreover, the bicycle itself becomes a convenient and health-giving transport means for the both partners. The devices set is also efficient when mounted on tandem bicycle and other motor-less vehicles. For example, a tricycle with the devices set mounted on it can be used by two persons (one of them between the rear wheels) or even by three (two of them above the rear wheels) cyclists.

### 3. BRIEF DESCRIPTION OF THE DRAWINGS

The main point of the invention will become more apparent from the following description of some its embodiments with the reference to the following drawings:

FIG. 1 is a side view of the bicycle with the devices set for biking upright mounted on it;

FIG. 2 is a side view of the rear bicycle wheel with housing for a single supporting pole mounted above it and the view of the pedal bicycle drive construction;

FIG. 3 is a view of the preferred embodiment of the universal support assembly containing several parts;

FIG. 4 is a view of a supporting pole and its housing mounted next to the support;

FIG. 5 is a side view from the rear bicycle wheel on the left side pedal lever (rocker) with a spiral bending spring;

FIG. 6 is a view of a bicycle pedal cartridge, supplemented with a free wheeling mechanism.

### DETAILED DESCRIPTION OF THE PREFERRED EMBODIMENT

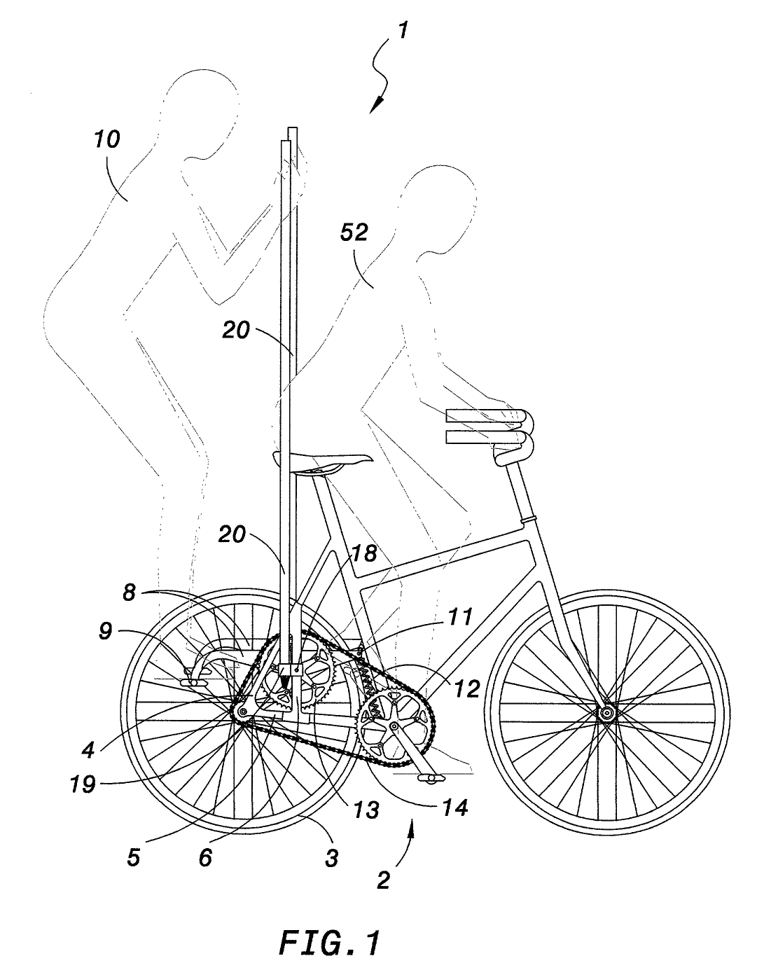

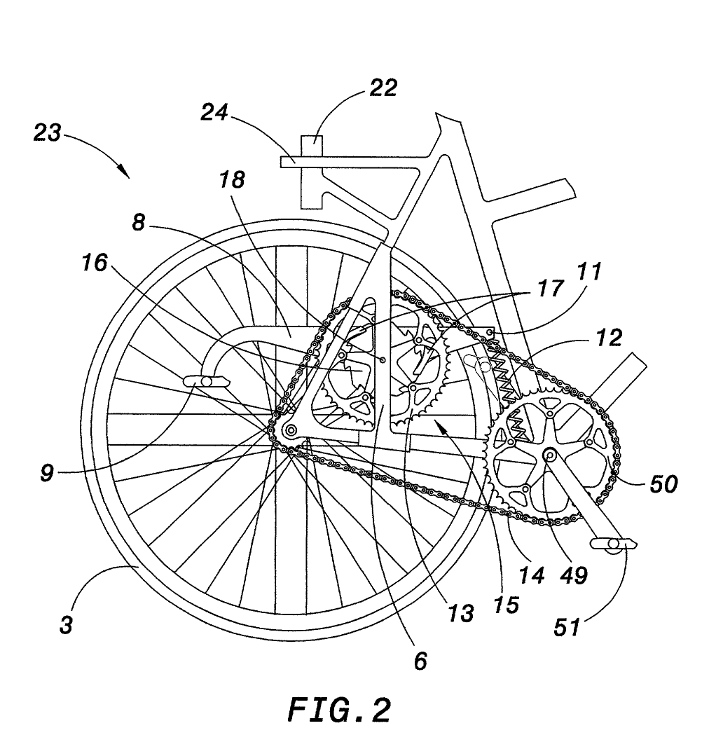

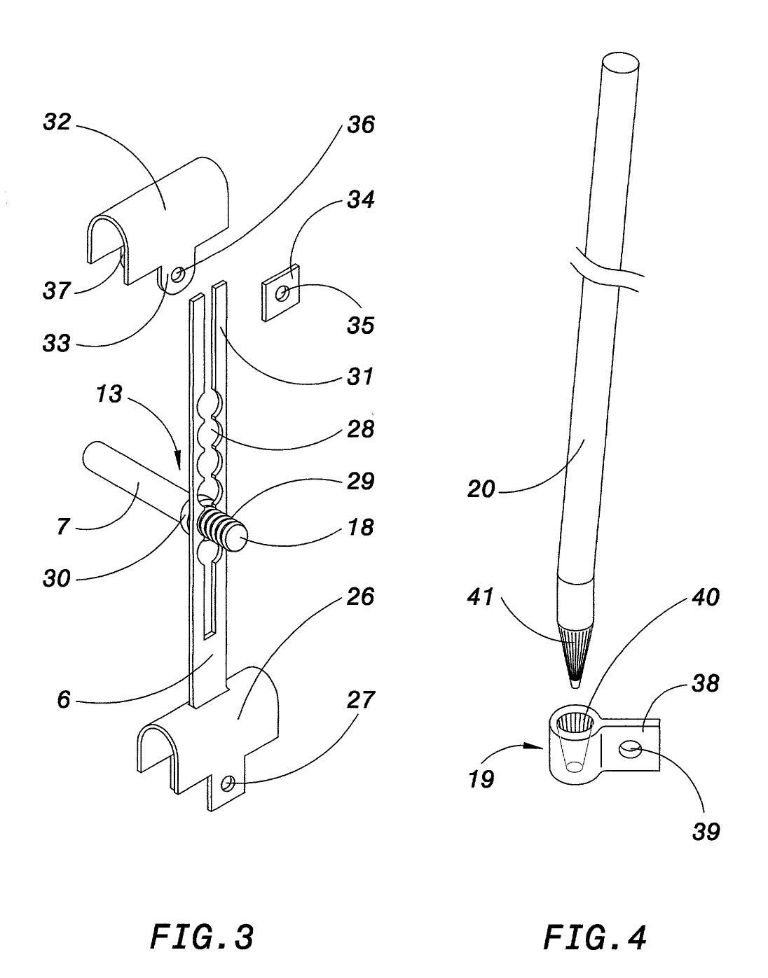

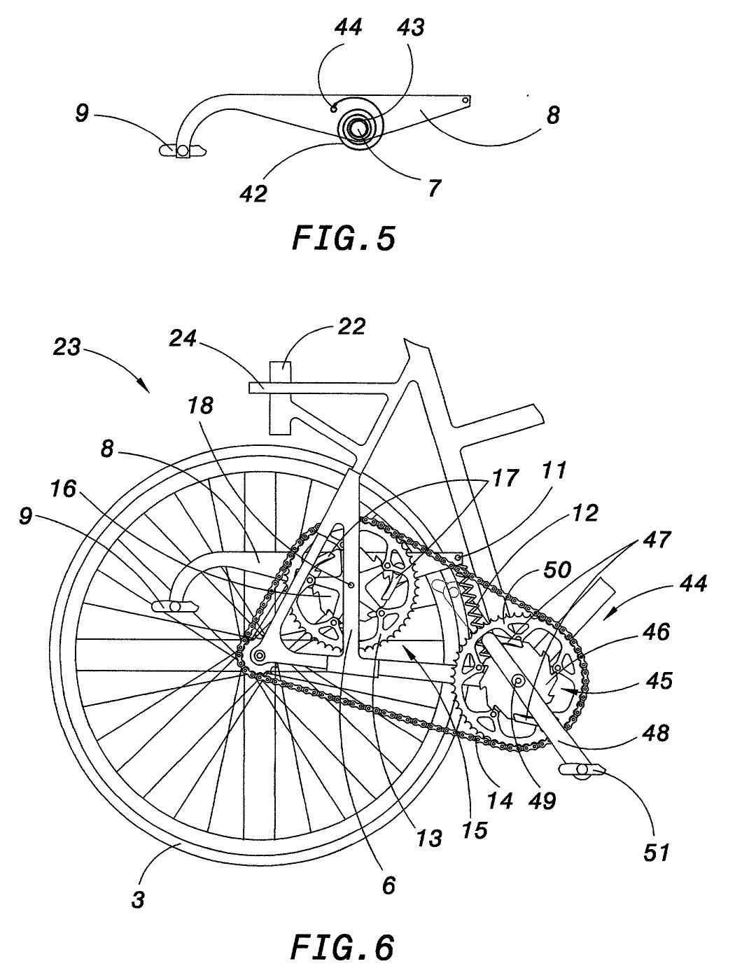

FIG. 1. is a side view of bicycle 1 from the right direction with devices set for biking upright mounted on its frame 2. Supports 6 with semi-axles 7 are rigidly and coaxially fixed to the right and to the left of rear wheel 3 between upper and lower forks 4 and 5 of frame 2 (FIG. 3.). On each semi-axle a rocker-shaped pedal lever 8 is mounted, which can be turned around its semi-axle. Pedal 9 is hinged-mounted at the rear end of each rocker 8, designed for the second cyclist's foot 10, who is positioned upright above wheel 3. The axles of pedal 9 hinges are fixed on one straight line. In front of wheel 3 front ends 11 of rockers are interconnected and with the upper end of tension spring 12, the lower end of the spring being fastened to the lower part of frame 2. Sprocket embraced from the top by somewhat elongated driving chain 14 of the bicycle power transmission is mounted on right semi-axle 7 next to rocker 8. Sprocket 13 is connected to the right rocker 8 by using of free wheeling ratchet mechanism 15 (FIG. 2.), having ratchet-wheel 16 rigidly fastened to sprocket 13 and ratchet pawl 17 mounted on right rocker 8. Housings 19 with supporting poles 20 for cyclist hands 21 inserted into them are mounted on outside ends 18 of semi-axles 7. More detailed description of mechanism 15 and housing 22 mounting option for single supporting pole 20 is given in description of FIG. 2. FIG. 2 shows a side view from the right direction of rear wheel 3 of bicycle 23, in which housing 22 for a single supporting pole 20 is fastened on shank 24 above wheel 3. This is the only difference between the devices sets mounted on bicycles 1 and 23. Sprocket 13 mounted on right semi-axle 7 next to its flange 25 (FIG. 3.) can be rotated around this semi-axle. Ratchet-wheel 16 of free wheeling mechanism 15 is rigidly fastened to the right side of the sprocket facing the right rocker 8. On the right side of right rocker 8 which is mounted on the end of semi-axle 7 near to wheel 3, ratchet pawls 17 are fixed, and will be coupled with ratchet-wheel 16 when the front end 11 of rocker 8 will incline downwards, what corresponds to the working stroke of driving chain 14 of the bicycle power transmission. FIG. 3. shows the view of the universal design of support 6, which consists of several parts. Such support can be easily mounted on most of the existing bicycles. Its lower supporting clamp 26 is put on the nib of lower fork 5 of frame 2. Bolt for tightening clamp 26 is inserted into holes 27. Outer end 18 of semi-axles 7 with threading 29 is passed through grooves 28 of support 6. Its flange 30 is forced against nibs of fork 31 of support 6. The upper clamp 32 is put on the nib of upper fork 4 of frame 2. Nibs of fork 31 are pressed from outside to flange 33 of clamp 32, further retainer plate 34 with hole 35 which is aligned with holes 36 in flanges 33 and 37 is laid on the nibs from outside. Bolt for tightening clamp 32 and fork 31 is passed through these holes. Housing 19 is put on end 18 of semi-axle 7 for mounting supporting pole 20. The respective design is illustrated in FIG. 4. Nut with washer is put on threaded part 29 of end 18. FIG. 4. shows the view of housing 19 and supporting pole 20 mounted on semi-axles 7. The housing has lug 38 with hole 39, which is put on end 18 of semi-

I claim:

1. The devices set for motor-less vehicle for biking upright, particularly for bicycle having power transmission, mainly chain, which comprises:
Supports designed for rigid mounting on the frame of the vehicle next to its rear wheel;
Coaxial and pairwise semi-axles that should be mounted each one on its respective support;
Levers, for example rockers, with pedals for the upright cyclist for hinged mounting on the mentioned semi-axles, wich should be pairwise and rigidly interconnected;
A spring with one end that should be connected to the above mentioned pedal lever and the other end that should be rigidly mounted to the frame of the mentioned vehicle, used for accumulation of tilt energy of pedal levers pushed by the mentioned cyclist;
A sprocket that should be mounted on one of the semi-axles, embraced by the driving chain of the vehicle power transmission, and the mentioned sprocket should be connected to the mentioned pedal lever by using a free wheeling mechanism, for example a ratchet gear, which transmits the effort of the mentioned cyclist to the driving chain to allow its motion in the working direction, what provides an increase in the operational efficiency of the vehicle while at least one cyclist is riding upright.

2. The set as recited in claim 1 wherein the mentioned supports are made sectional from interconnected details.

3. The set, as recited in claim 1, which further comprises special housings for the upright cyclist's supporting poles which were designed for the hands of the upright cyclist and should be mounted from both sides of the rear wheel of the operator-powered vehicle.

4. The set as recited in claim 1, which further comprises a shank with a housing for a single mentioned supporting pole and should be mounted above the rear vehicle wheel.

5. The set as recited in claims 3 or 4, which comprises the mentioned supporting poles.

6. The set as recited in claim 5, in which the supporting poles are bent and made with conic lower part.

7. The set as recited in claim 5, in which the supporting poles are made folding, for example telescopic.

8. The set as recited in claim 1, formed as an integral part of the operator powered vehicle.

9. A motor-less vehicle, particularly bicycle containing the following parts: a frame, a handle bar, front and rear wheels, a power transmission chain, a handbrake, the devices set as recited in claim 1 and the pedal cartridge, which includes:
Levers, which should be rigidly mounted on the common pedal axle.
The cyclist's pedals that should be mounted on the ends of the above-mentioned levers.
Driving sprocket embraced by a power transmission and loosely mounted on the above-mentioned pedal axle.
Free wheeling mechanism, for example a ratchet gear, whose driving section is rigidly connected to the common pedal axle and the slack section of the mechanism is connected with the mentioned driving sprocket which rotates together with the rotation of the common pedal axle in the work direction, when the work direction is forward, what provides an increase in the operational efficiency of the vehicle while at least one cyclist is riding upright.
